(19) United States
(12) Patent Application Publication
(10) Pub. No.: US 2002/0026713 A1
(43) Pub. Date: Mar. 7, 2002

(54) Hair-cutting scissor with combination cutting and blending blades

(76) Inventor: Dobrinick Robert, Decatur, IL (US)

Correspondence Address: BANNER & WITCOFF, 1001 G STREET N W, SUITE 1100, WASHINGTON, DC, 20001, US

(21) Appl. No.: 09/985,791

(22) Filed: Nov. 6, 2001

Related U.S. Application Data
(63) Continuation of application No. 08/926,971, filed on Sep. 10, 1997.

(51) Int. Cl. B26B 13/06

(52) U.S. Cl. 30/254

(57) ABSTRACT

Cutting and blending scissors for hair is made of a pair of cutting blades held in rotating connection by a self locking nut. One of the blades including a cutting surface on one end and a finger hold on the other. The blade further includes a serrated blending area with a plurality of closely spaced teeth. The second blade also includes a cutting surface on one end and another finger hold on the other. The combination of blades and serrated portion allows the tips of the hair to be blended when cut, thus giving a smooth cut without any additional effort on the part of the operator.

### BACKGROUND OF THE INVENTION

The present invention relates generally to the field of hair care products and accessories and more particularly, is directed to a hair-cutting scissor which cuts and blends hair in the same stroke.

A number of cutting scissors are already know in the prior art. For example, U.S. Pat. No. 3,831,277 in the name of Nagat discloses a pair of scissors which perform both a cutting and thinning operation. One handle operates and is fixed to a thinning blade, while the other handle is a cutting blade.

U.S. Pat. Nos. 4,170,064 in the name of Senk and 2,558,264 in the name of Metcalfe also disclose scissors with cutting and thinning blades.

While the above described prior art scissors have cutting and thinning blades together, they remain deficient in a number of areas. For example, the teeth in the thinning blades of the prior art shears are spaced wide apart. Thinning scissors are designed for thinning the hair approximately halfway down the hair shaft to remove bulk. Such scissors are not acceptable for thinning the tip end of the hair because they leave the hair ends choppy and the hair does not lay well.

Other scissors known in the prior art include U.S. Pat. No. 3,250,001 in the name of Cercone; U.S. Pat. No. 3,257,723 also in the name of Cercone and British Patent No. 699,498. The Cercone '001 patent, for example, discloses barber scissors comprising a straight cutting blade 4 which cooperates with blade 6 having a plurality of closely separated teeth 8 extending along its length. The serrated teeth 8 cooperate with the cutting edge of blade 4 in order to cut strands of hair lying between the points of the teeth on blade 6 and the smooth cutting edge on blade 4.

The Cercone '001 and '723 scissors are nothing more that thinning scissors and are not for cutting. The '498 British patent is merely a pair scissors with a guard and only does one operation at a time.

Accordingly, there is a need in the art for an improving pair of hair-cutting and thinning scissors in order to overcome the above mentioned shortcoming of prior art scissors.

### SUMMARY OF THE INVENTION

Accordingly, it is the overall objective of the present invention to provide a combination cutting and blending scissors which overcomes the above noted deficiencies of cutting and thinning shears known in the prior art.

It is another objective of the present invention to provide a combination cutting and blending scissors which is easy to use and performs the cutting and blending operation in one stroke.

It is still further objective of the present invention to provide a combination cutting and blending scissors which is inexpensive to manufacture using known techniques.

Further details and features of the present invention will be understood from reading the detailed description of the invention in view of the drawings.

### BRIEF DESCRIPTION OF THE DRAWINGS

FIG. 1 is a front view of a cutting and blending scissors in accordance the present invention; and

FIG. 2 is a back view of the cutting and blending scissors of the present invention showing the blending blade.

### DESCRIPTION OF THE PREFERRED EMBODIMENT

The cutting and blending scissors of Applicant's invention will now be described with reference to the drawing.

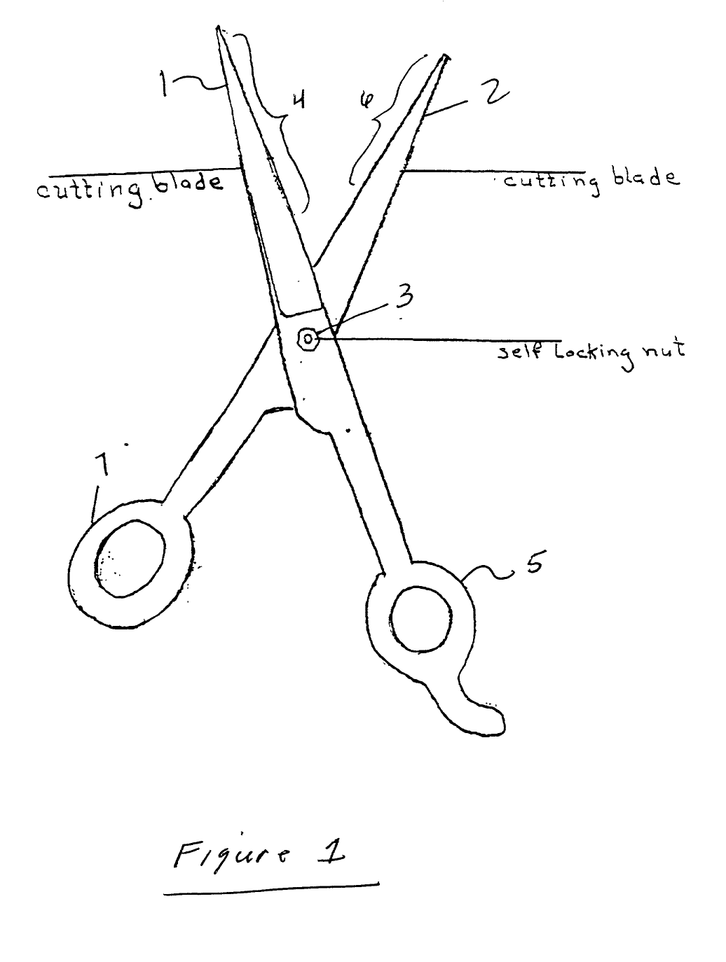

As shown in FIG. 1, the scissors comprises a pair of cutting blades 1 and 2 held in rotating connection by a self locking nut 3. Blade 1 including a cutting surface 4 on one end and a finger hold 5 on the other. Blade 2 likewise includes a cutting surface 6 on one end and a finger hold 7 on the other.

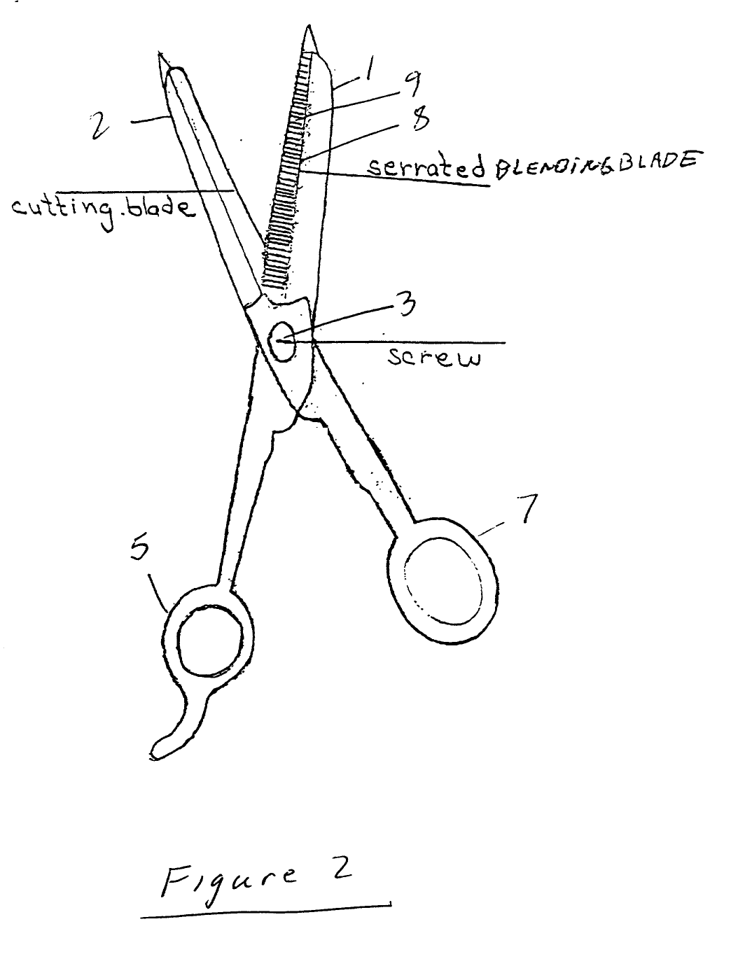

FIG. 2 illustrates the reverse side of Applicant's cutting and blending scissors. As shown in FIG. 2, blade 1 includes a serrated blending area 8 with a plurality of closely spaced teeth 9. In accordance with the present invention, the combination of cutting blade 2 and the serrated portion of blade 1 allows the operator to take a section of hair with his fingers or over a comb and blunt cut it. At the same time, the tips of the hair cut are blended, thus giving a smooth cut without any additional effort on the part of the operator. Thus, the cutting and blending operation can be performed in one stroke, making the use of Applicant's invention more efficient and easier to use than scissors known in the prior art.

It should be obvious from the above-discussed apparatus embodiment that numerous other variations and modifications of the apparatus of this invention are possible, and such will readily occur to those skilled in the art. Accordingly, the scope of this invention is not to be limited to the embodiment disclosed, but is to include any such embodiments as may be encompassed within the scope of the claims appended hereto.

I claim:

1. A pair of scissors, said scissors comprising:
a first blade having a cutting edge on one end and a finger hold on the other end, wherein said cutting edge includes a serrated portion; and
a second blade having a cutting edge on one end and a finger hold on the other end, wherein said first and second blades are held together in a pivoting relationship at a central location.

2. A pair of scissors according to claim 1, wherein said serrated portion is formed of a plurality of closely spaced teeth.

3. A pair of scissors according to claim 2, wherein said central location of said first and second blades includes fastening means for holding said first and second blades in said pivoting relationship.

4. A pair of scissors according to claim 3, wherein said fastening means is a screw.

5. A pair of scissors according to claim 3, wherein said fastening means is a lock nut.

6. A pair of scissors according to claim 5, wherein said serrated portion extends along the full duration of said cutting edge of said first blade.
